(19) United States
(12) Patent Application Publication
(10) Pub. No.: US 2026/0331539 A1
(43) Pub. Date: Oct. 22, 2026

(54) STATIONARY FUEL CELL SYSTEM AND POWER GENERATION PLANT

(71) Applicant: NISSAN MOTOR CO., LTD., Yokohama-shi, Kanagawa (JP)

(72) Inventors: Hiroyuki ISODA, Kanagawa (JP); Masahiro USUDA, Kanagawa (JP)

(73) Assignee: NISSAN MOTOR CO., LTD., Yokohama-shi, Kanagawa (JP)

(21) Appl. No.: 19/117,535

(22) PCT Filed: Oct. 5, 2022
(86) PCT No.: PCT/JP2022/037283

§ 371 Date: Apr. 1, 2025

(51) Int. Cl. H01M 8/04082; H01M 8/04029; H01M 8/12; H01M 8/1231

(52) U.S. Cl. CPC H01M 8/04201; H01M 8/04029; H01M 8/1231; H01M 2008/1293; H01M 2250/10

(57) ABSTRACT

A stationary fuel cell system includes: a power generation module including an auxiliary machine structure including an auxiliary machine that receives and transmits gas from and to a fuel cell stack, and a fuel cell stack connected to at least one face of the auxiliary machine structure in an up-down direction, a box-shaped frame body made of frame members, the power generation module being disposed inside the frame body, pipes through which gas supplied to the power generation module or discharged from the power generation module flows, and branch pipes branched from the pipes and connected to the power generation module. The auxiliary machine structure is supported by cross members each extending in a horizontal direction and provided on each of a pair of side faces of the frame body facing each other with the power generation module therebetween.

### TECHNICAL FIELD

The present invention relates to a stationary fuel cell system and a power generation plant.

### BACKGROUND ART

As a configuration of a stationary fuel cell system, JP2009-266772A discloses a fuel cell system including a fuel cell package that accommodates a fuel cell, a base provided within the fuel cell package and on which the fuel cell is installed, and a slide device provided on the base. This slide device has a function of allowing the fuel cell to slide forward from an opening provided at front of the fuel cell package. A reason for providing such a slide device is to improve operability by allowing the fuel cell to be easily pulled out from the opening of the fuel cell package during operations such as maintenance.

### SUMMARY OF INVENTION

Incidentally, a fuel cell system requires pipes for supplying fuel and air required for power generation to a fuel cell stack, and wirings for driving auxiliary machines such as a fuel injection device. However, the above literature does not describe the pipes and the wirings. For example, when a fuel cell needs to be replaced, there is a need to remove all pipes and the like from the fuel cell before pulling out the fuel cell from a fuel cell package, and connect all the pipes to the fuel cell when a new fuel cell is accommodated in the fuel cell package. That is, to improve operability such as maintenance, there is a need to consider operability of connection and disconnection of pipes and the like, and in this respect, there is room for improvement in the fuel cell system in the above literature.

Therefore, an object of the present invention is to provide a fuel cell system that is excellent in operability such as maintenance.

According to one aspect of the present invention, there is provided a stationary fuel cell system including: a power generation module including an auxiliary machine structure including an auxiliary machine that receives and transmits gas from and to a fuel cell stack, and a fuel cell stack connected to at least one face of the auxiliary machine structure in an up-down direction; a box-shaped frame body made of a plurality of frame members, the power generation module being disposed inside the frame body. The system further including: pipes through which gas supplied to the power generation module or discharged from the power generation module flows; and branch pipes branched from the pipes and connected to the power generation module. The auxiliary machine structure is supported by cross members each extending in a horizontal direction and provided on each of a pair of side faces of the frame body facing each other with the power generation module therebetween, and when one of a pair of side faces of the frame body, orthogonal to any of the pair of side faces on which the cross member is provided, is an insertion face through which the power generation module passes when inserting the power generation module into the frame body, and the other is a non-insertion face, a connection portion between the branch pipes and the auxiliary machine structure are on a non-insertion face side of the auxiliary machine structure.

### BRIEF DESCRIPTION OF DRAWINGS

FIG. 1 is a perspective view illustrating a schematic configuration of a stationary fuel cell system.

FIG. 2 is a front view of the stationary fuel cell system. FIG. 3 is a rear view of the stationary fuel cell system. FIG. 4 is a left side view of the stationary fuel cell system. FIG. 5 is a diagram illustrating fuel system components extracted from the stationary fuel cell system.

FIG. 6 is a view of a pair of cross members and a power generation module in a state before assembly, viewed from a rear side.

FIG. 7 is a front view of a power generation plant using the fuel cell system in FIG. 1.

FIG. 8A is a diagram illustrating a pipe path of an intake system. FIG. 8B is a diagram illustrating a pipe path of an exhaust system.

FIG. 8C is a diagram illustrating a circuit of a power system.

### DESCRIPTION OF EMBODIMENTS

Hereinafter, an embodiment of the present invention will be described with reference to the drawings.

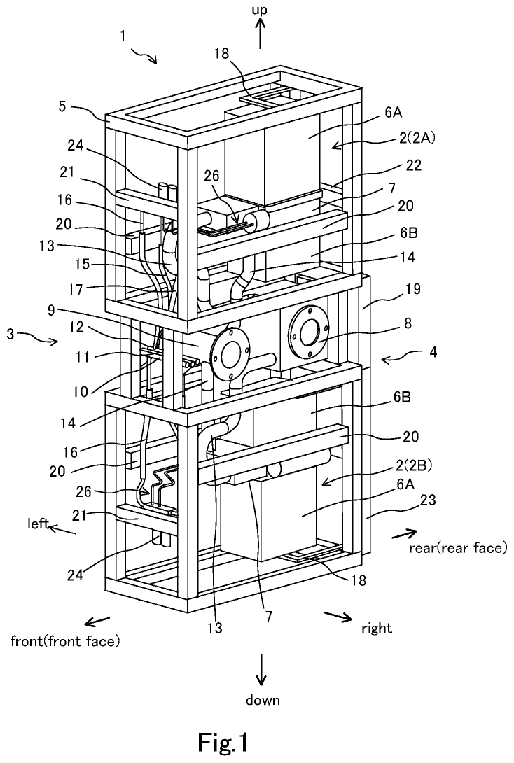

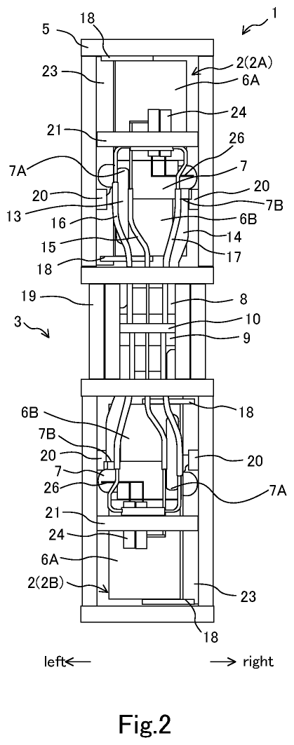

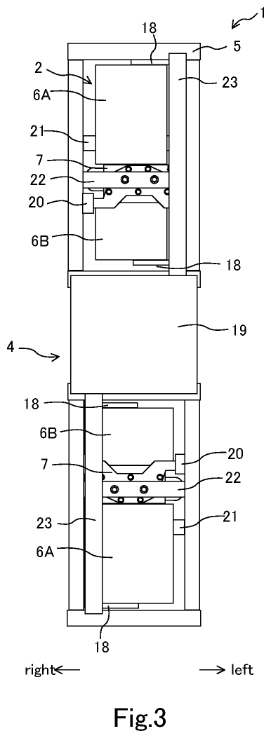

FIG. 1 is a perspective view illustrating a schematic configuration of a stationary fuel cell system (hereinafter, simply referred to as a fuel cell system) 1 according to the embodiment of the present invention. FIG. 2 is a front view of the fuel cell system 1. FIG. 3 is a rear view of the fuel cell system 1. FIG. 4 is a left side view of the fuel cell system 1. FIG. 5 is a diagram illustrating fuel system components extracted from the fuel cell system 1. In the present embodiment, a height direction of the fuel cell system 1 is defined as an up-down direction, a flow path direction of an intake pipe 8, an exhaust pipe 9, and the like described later is defined as a left-right direction, and a direction orthogonal to the up-down direction and the left-right direction is defined as a front-rear direction. Further, in the front-rear direction, a side of an auxiliary machine structure 7 to which connection portions with respective pipes 13, 14 described later are provided is defined as a front (front face). The left-right direction is defined based on a front view.

The fuel cell system 1 according to the present embodiment is used for stationary use. A fuel cell used in the fuel cell system 1 is a solid oxide fuel cell.

The fuel cell system 1 includes two power generation modules 2, one pipe module 3, one power recovery module 4 as an electrical equipment module, and a frame body 5 that supports them.

The power generation module 2 includes the auxiliary machine structure 7, a first fuel cell stack 6A disposed on one face of the auxiliary machine structure 7 in the up-down direction, and a second fuel cell stack 6B disposed on the other face thereof. A fuel cell stack 6 is formed by laminating a plurality of unit cells in the up-down direction. A dimension of the first fuel cell stack 6A in the up-down direction is larger than a dimension of the second fuel cell stack 6B in the up-down direction. That is, the first fuel cell stack 6A has a larger number of laminated unit cells than the second fuel cell stack 6B.

When there is no need to distinguish between the first fuel cell stack 6A and the second fuel cell stack 6B, the first fuel cell stack 6A and the second fuel cell stack 6B are referred to as the fuel cell stack 6. In the present embodiment, a configuration in which the fuel cell stacks 6 are disposed on both faces of the auxiliary machine structure 7 in the up-down direction will be described. However, a configuration in which the fuel cell stack 6 is disposed on only one of the faces may be used.

The auxiliary machine structure 7 is a housing including an auxiliary machine (for example, a heat exchanger or a combustor) that receives and transmits gas from and to the fuel cell stack 6.

The power generation module 2 includes a fuel injection unit 24 that injects fuel to be supplied to the fuel cell stack 6 of the power generation module 2. Although the fuel injection unit 24 according to the present embodiment includes two fuel injection valves, the number of fuel injection valves is not limited to this.

The pipe module 3 includes the intake pipe 8 through which air to be supplied to the power generation module 2 flows, the exhaust pipe 9 through which gas discharged from the power generation module 2 flows, a fuel pipe 11 through which fuel to be supplied to the power generation module 2 flows, and injection unit cooling water pipes 10, 12 through which cooling water for cooling the fuel injection unit 24 flows. The injection unit cooling water pipes 10, 12 may be simply referred to as “cooling water pipes 10, 12” in the following description. The cooling water pipe 10 may be referred to as an inlet cooling water pipe 10, and the cooling water pipe 12 may be referred to as an outlet cooling water pipe 12.

The power recovery module 4 includes a power box 19 that accommodates equipment and wirings for recovering power generated by the power generation module 2 and transmitting the recovered power to a power converter 43 described later, and equipment and wirings for drawing in power required to drive auxiliary machines or the like from external equipment. The power box 19 is made of a metal member subjected to an insulation treatment. A known treatment can be used for the insulation treatment.

The frame body 5 includes a plurality of frame members, a cross member 20, and first and second stays 21, 22, which are disposed to surround the two power generation modules 2 and one pipe module 3.

Inside the frame body 5, the two power generation modules 2 are stacked and disposed in the up-down direction, and the pipe module 3 is disposed therebetween. Hereinafter, when there is a need to distinguish between the upper and lower power generation modules 2, the upper one is referred to as an upper power generation module 2A, and the lower one is referred to as a lower power generation module 2B.

By stacking and disposing the two power generation modules 2 in the up-down direction, an area required to install the fuel cell system 1 can be made smaller than that in a configuration in which the two power generation modules 2 are installed on the same face (hereinafter, also referred to as horizontal placement). Further, in a case of the horizontal placement, pipes such as the intake pipe 8 and the exhaust pipe 9 are disposed between the adjacent power generation modules 2, and pipes branched from the pipes to the respective auxiliary machine structure 7 are installed. In contrast, in the fuel cell system 1 according to the present embodiment, since the pipe module 3 is disposed between the power generation modules 2 stacked and disposed in the up-down direction, an area occupied by the pipes is smaller than that in the horizontal placement when viewed from above. That is, according to the fuel cell system 1 of the present embodiment, the area required to install the fuel cell system 1, which includes the plurality of power generation modules 2, can be further reduced.

The frame body 5 includes, for example, an upper portion that surrounds the upper power generation module 2A, a lower portion that surrounds the lower power generation module 2B, and an intermediate portion that surrounds the pipe module 3. The upper portion includes at least twelve frame members assembled in a box shape to surround the upper power generation module 2A, the cross member 20 disposed to cross left and right side faces defined by the frame members in the front-rear direction, and the first stay 22 and the second stay 21 disposed to cross front and rear side faces (that is, a front face and a rear face) defined by the frame members in the left-right direction. The lower portion has the same configuration as the upper portion. The intermediate portion includes at least four frame members that connect the upper portion and the lower portion at predetermined intervals in the up-down direction.

The fuel cell system 1 includes a power line for supplying, from an externally installed power source, power required for operations of the fuel injection unit 24, auxiliary machines included in the auxiliary machine structure 7, valve bodies included in the intake branch pipe 13 and the exhaust branch pipe 14 to be described later, actuators for driving the valve bodies, and the like (hereinafter, collectively referred to as “auxiliary machines”). The fuel cell system 1 also includes a signal line for sending a signal required for control from an externally installed control device to auxiliary machines. Hereinafter, these are also collectively referred to as “power and signal lines”. The power and signal lines are routed along the frame member of the frame body 5 from the power recovery module 4 to the auxiliary machines to be connected. The power and signal lines can be divided into a main wiring connected to an externally installed power supply and control device, and a branch wiring branched from the main wiring and connected to auxiliary machines of the respective fuel cell system 1.

The upper power generation module 2A is in a state in which the first fuel cell stack 6A is disposed above the auxiliary machine structure 7, and the second fuel cell stack 6B is disposed below the auxiliary machine structure 7. Hereinafter, this state is also referred to as an upright state. On the other hand, the lower power generation module 2B has the same structure as the upper power generation module 2A and is in a state in which the first fuel cell stack 6A is disposed below the auxiliary machine structure 7, and the second fuel cell stack 6B is disposed above the auxiliary machine structure 7. That is, the lower power generation module 2B is in a state in which the upper power generation module 2A is turned upside down about an axis extending in the front-rear direction. Hereinafter, this state is also referred to as an inverted state. A portion of the frame body 5 that surrounds the upper power generation module 2A and a portion of the frame body 5 that surrounds the lower power generation module 2B are also in a relationship of having the same structure but inverted upside down. In this way, by using two power generation modules 2 having the same structure with one in the upright state and the other in the inverted state, cost can be reduced as compared with a case of using a plurality of types of power generation modules 2. Further, by using the same structure for the upper and lower portions, the same shapes and dimensions can be used for respective pipes and respective wirings between the pipe module 3 and the power generation module 2, which also reduces the cost.

The two power generation modules 2 are disposed at positions where a center axis Cm thereof in the front-rear direction is offset toward a rear side with respect to a center axis Cf of the frame body 5 in the front-rear direction (see FIG. 4). The power generation module 2 is fixedly supported by a pair of cross members 20 provided on a right side face and a left side face of the frame body 5 and the first stay 22 provided on a rear face of the frame body 5. The cross member 20 connects a pair of frame members extending in the up-down direction among the frame members that define the left and right side faces of the frame body. The first stay 22 connects a pair of frame members that define the rear face of the frame body 5. A method of fixing the power generation module 2 to the frame body 5 will be described later.

Each pipe of the pipe module 3 is disposed such that a direction of a flow path is the left-right direction of the frame body 5. The intake pipe 8 and the exhaust pipe 9 are supported by the frame body 5 via stays (not illustrated) or the like. The fuel pipe 11 and the cooling water pipes 10, 12 are supported by a bracket 25 provided on the frame body 5.

The pipe module 3 is disposed between the upper power generation module 2A and the lower power generation module 2B as described above. More specifically, the intake pipe 8 is disposed at a position overlapping the fuel cell stack 6 in a top view, and the exhaust pipe 9 is disposed at a position not overlapping the fuel cell stack 6 in the top view. By disposing the exhaust pipe 9 through which high-temperature exhaust gas flows in this manner, heat generated from the exhaust pipe 9 is likely to escape upward, and thus an increase in temperature of electrical components such as the fuel injection unit 24 can be prevented.

Flanges are provided at both ends of the intake pipe 8 and the exhaust pipe 9 in the left-right direction. When a plurality of the fuel cell systems 1 are coupled in the left-right direction as described later, the flanges are fastened by bolts or the like.

The exhaust pipe 9 is a cylindrical single pipe member except for flanges at both ends. On the other hand, the intake pipe 8 has a flow path cross-sectional area of a portion interposed between the flanges at both ends that is larger than an area of an opening provided in the flange. The flow path cross-sectional area of the portion interposed between the flanges at both ends of the intake pipe 8 is larger than a flow path cross-sectional area of a portion interposed between the flanges at both ends of the exhaust pipe 9. In other words, the intake pipe 8 has a larger flow path volume than the exhaust pipe 9. The intake pipe 8 according to the present embodiment is a rectangular parallelepiped having circular openings on left and right side faces thereof. However, the intake pipe 8 is not limited thereto, and may have any shape that satisfies the above conditions.

Both ends of the fuel pipe 11 and the cooling water pipes 10, 12 are provided with ribs (not illustrated). When the plurality of fuel cell systems 1 are coupled in the left-right direction, the fuel pipes 11 and the cooling water pipes 10, 12 of the adjacent fuel cell systems 1 are connected via rubber pipes (not illustrated) or the like.

The intake pipe 8 and the power generation module 2 are connected via an intake branch pipe 13. More specifically, the intake branch pipe 13 branched from the intake pipe 8 is connected to an intake port 7A provided in the auxiliary machine structure 7.

The exhaust pipe 9 and the power generation module 2 are connected via the exhaust branch pipe 14. More specifically, the exhaust branch pipe 14 branched from the exhaust pipe 9 is connected to an exhaust port 7B provided in the auxiliary machine structure 7. Since the exhaust gas discharged from the power generation module 2 reaches a high temperature and the connection portion between the auxiliary machine structure 7 and the exhaust branch pipe 14 also reaches a high temperature, the exhaust branch pipe is made of a metal member. In the intake branch pipe 13, since the temperature of the air flowing inside and the temperature of the connection portion between the auxiliary machine structure 7 and the intake branch pipe 13 are lower than those of the exhaust branch pipe 14, a rubber pipe can be used for a portion where heat is less likely to be transferred from the power generation module 2, the exhaust branch pipe 14, and the exhaust pipe 9, all of which reach a high temperature.

As described above, the upper power generation module 2A is in the upright state, the lower power generation module 2B is in the inverted state, and the pipe module 3 is disposed between the two power generation modules 2. Accordingly, in both the power generation modules 2, the second fuel cell stack 6B having a shorter dimension in the up-down direction than the first fuel cell stack 6A is disposed closer to the pipe module 3. In other words, a distance from the pipe module 3 to each auxiliary machine structure 7 is shorter than that in a case in which the upper power generation module 2A is in the inverted state and the lower power generation module 2B is in the upright state.

The intake port 7A and the exhaust port 7B are disposed on a front side of the auxiliary machine structure 7 in a top view. As described above, the power generation module 2 is located at a position offset toward the rear side with respect to the frame body 5. Therefore, distances between the intake port 7A, the exhaust port 7B, and the frame body 5 are secured, creating more room for routing the intake branch pipe 13 and the exhaust branch pipe 14. In the present embodiment, the exhaust branch pipe 14 is provided on a lower face of a portion of the auxiliary machine structure 7 that protrudes toward the front side with respect to the fuel cell stack 6, and is connected from below, which is also included in “disposed on the front side of the auxiliary machine structure 7 in the top view”. Similarly to the intake port 7A, the exhaust port 7B may be opened in a direction of the front face, and the exhaust branch pipe 14 may be connected from the front face.

If either the intake port 7A or the exhaust port 7B is disposed on the rear side of the auxiliary machine structure 7 in the top view, an amount by which the power generation module 2 can be offset toward the rear side is limited due to presence of a pipe connected thereto. As a result, wasted spaces are generated on the front side and the rear side. On the other hand, in the fuel cell system 1 according to the present embodiment, since the intake port 7A and the exhaust port 7B are consolidated on the front side, a rear face of the power generation module 2 can be brought closer to a rear face of the frame body 5. That is, according to the present embodiment, wasted spaces generated between the rear face of the frame body 5 and the rear face of the power generation module 2 (IS in FIG. 4) can be further reduced.

In the upper power generation module 2A, the intake port 7A is disposed on a left side and the exhaust port 7B is disposed on a right side in the front view. On the other hand, in the lower power generation module 2B, the intake port 7A is disposed on the right side and the exhaust port 7B is disposed on the left side in the front view. That is, arrangements of the intake ports 7A and the exhaust ports 7B are reversed between the upper power generation module 2A and the lower power generation module 2B. Accordingly, a position of a connection portion of the intake pipe 8 with the intake branch pipe 13 for the upper power generation module 2A and a position of a connection portion of the intake pipe 8 with the intake branch pipe 13 for the lower power generation module 2B can be shifted in the left-right direction. Although the intake branch pipe 13 has an accessory device such as a valve body and an actuator for driving the valve body (both not illustrated). However, by shifting the positions of the two connection portions in the left-right direction in this way, positions of the accessory devices can be dispersed, creating more room for routing the two intake branch pipes 13. Further, when the two connection portions are located close to each other, a problem such as air being less likely to flow to either of the intake branch pipes 13 may occur. However, the problem can be solved by shifting the positions of the two connection portions in the left-right direction as described above. The same applies to connection portions of the exhaust pipe 9 with the two exhaust branch pipes 14.

In the present embodiment, since the power generation modules 2 having the same structure are used in the upright state and the inverted state, it is natural that the arrangements of the intake ports 7A and the exhaust ports 7B are reversed as described above. However, even in a case in which two power generation modules 2 having different structures are used, the arrangements of the intake ports 7A and the exhaust ports 7B are reversed between the upper power generation module 2A and the lower power generation module 2B to solve the above problem.

Incidentally, when the fuel cell system 1 is used in a power generation plant or the like, maintenance and inspection operations such as confirmation of presence or absence of leakage from each pipe and replacement of consumables or defective parts are required. In the fuel cell system 1 according to the present embodiment, since the power generation module 2 is disposed offset toward the rear side with respect to the frame body 5, and the intake ports 7A and the exhaust ports 7B of the upper and lower power generation modules 2 are all disposed on the front side, accessory devices such as the shutoff valve described later included in the pipe module 3 can also be consolidated on the front side. Therefore, according to the fuel cell system 1 of the present embodiment, an amount of movement of an operator during maintenance and inspection operations is reduced, and operation efficiency can be improved.

Further, during the maintenance and inspection operations, when a position of a portion to be operated is low, the operator needs to bend down or, in some cases, lie down. In contrast, when the position of the portion to be operated is high, the operator needs to stretch or stand on a step stool. In either case, it is a factor of deteriorating operability. However, in the fuel cell system 1 according to the present embodiment, the upper power generation module 2A is in the upright state, the lower power generation module 2B is in the inverted state, and the pipe module 3 is disposed between the two power generation modules 2. Accordingly, positions of the auxiliary machine structures 7 of the upper and lower power generation modules 2 are brought closer to a center of the fuel cell system 1 in the up-down direction, and thus deterioration of operability can be prevented.

As a result of investigation by the inventors, it has been found that the deterioration of operability can be prevented when a height of the portion to be operated from an installation face is in a range of about 400 mm to 1500 mm. Therefore, although dimensions of the power generation module 2 and the frame body 5 can be set as desired, from a viewpoint of the above operability, the dimensions of the power generation module 2 and the frame body 5 are set such that heights of the intake ports 7A and the exhaust ports 7B of the upper and lower power generation modules 2 from the installation face are within the range of 400 mm to 1500 mm. It is desirable that a connection portion between a fuel supply pipe 26 and the auxiliary machine structure 7, which will be described later, is also within this range.

The fuel injection unit 24 is fixedly supported by the second stay 21 provided on a front face of the frame body 5. Fuel is supplied from the fuel pipe 11 to the fuel injection unit 24 via a fuel branch pipe 15, and is supplied from the fuel injection unit 24 to the auxiliary machine structure 7 via the fuel supply pipe 26, and supplied therefrom to the power generation module 2. Similarly to the intake port 7A and the exhaust port 7B, the connection portion between the fuel supply pipe 26 and the auxiliary machine structure 7 is disposed on the front side of the auxiliary machine structure 7 in the top view. The fuel injection unit 24 includes a cooling water gallery 27 that surrounds an injection portion of the fuel injection valve. The cooling water gallery 27 and the inlet cooling water pipe 10 are connected by a first cooling water branch pipe 17, and the cooling water gallery 27 and the outlet cooling water pipe 12 are connected by a second cooling water branch pipe 16. That is, cooling water is supplied from the inlet cooling water pipe 10 to the cooling water gallery 27 via the first cooling water branch pipe 17, cools the fuel injection valve there, and flows into the outlet cooling water pipe 12 via the second cooling water branch pipe 16.

The inlet cooling water pipe 10 is disposed on a non-insertion face side with respect to the fuel pipe 11, and the outlet cooling water pipe 12 is disposed on an insertion face side with respect to the fuel pipe 11. In other words, the inlet cooling water pipe 10 is disposed at a position farthest from the exhaust pipe 9, the outlet cooling water pipe 12 is disposed at a position closest to the exhaust pipe 9, and the fuel pipe 11 is disposed between the inlet cooling water pipe 10 and the outlet cooling water pipe 12. A reason for such a disposition is as follows.

The cooling water flowing through the cooling water pipes 10, 12 is for cooling the fuel injection unit 24 as described above. Therefore, it is desirable that a heat transfer amount from the exhaust pipe 9 through which the high-temperature exhaust gas flows is small in the inlet cooling water pipe 10 through which the cooling water flows before being used for cooling the fuel injection unit 24. On the other hand, since the cooling water used for cooling the fuel injection unit 24 is then cooled by a radiator (not illustrated), the outlet cooling water pipe 12 has a larger tolerance for the heat transfer amount from the exhaust pipe 9 than the inlet cooling water pipe 10. Further, from a viewpoint of reactivity in the fuel cell stack 6, it is desirable that the fuel is likely to be evaporated (that is, the temperature is high). However, it is not desirable that the temperature is high enough to generate bubbles in the fuel pipe 11. Therefore, the inlet cooling water pipe 10 for which the heat transfer amount from the exhaust pipe 9 is desired to be reduced is disposed at the position farthest from the exhaust pipe 9, the outlet cooling water pipe 12 having a small adverse effect due to heat of the exhaust pipe 9 is disposed at the position closest to the exhaust pipe 9, and the fuel pipe 11 which is desirably increased in temperature to a temperature at which the fuel is likely to be evaporated after fuel injection is disposed between the inlet cooling water pipe 10 and the outlet cooling water pipe 12.

The power box 19 is disposed between the upper and lower power generation modules 2 on the rear face of the frame body 5. The power generation module 2 and the power box 19 are electrically connected via a bus bar 18 as a branch power line. The bus bars 18 are taken out from faces of the fuel cell stack 6 that are opposite to a face in contact with the auxiliary machine structure 7 (that is, an upper face and a lower face), extend in a direction different from a direction in which the exhaust pipe 9 is located, and are connected to the power box 19 through wiring passages 23 provided along the frame members of the frame body 5. Here, “extend in a direction different from a direction in which the exhaust pipe 9 is located” means not approaching the exhaust pipe 9. A main power line 53 connected to the externally installed power converter 43 is accommodated in the power box 19, and the bus bar 18 is connected to the main power line 53. Similarly to the power box 19, the wiring passage 23 is also made of a metal member subjected to an insulation treatment. Accordingly, when disassembled for maintenance and inspection operations and the like, a frequency of the frame member coming into contact with electrically active portions such as the bus bar 18 and electric wirings.

When two power generation modules 2 are horizontally placed, there is a need to provide a space for installing the power box 19 separately from installation spaces for the power generation modules 2. However, according to the configuration of the present embodiment, there is no need to provide the space. That is, the area required to install the fuel cell system 1 can be reduced.

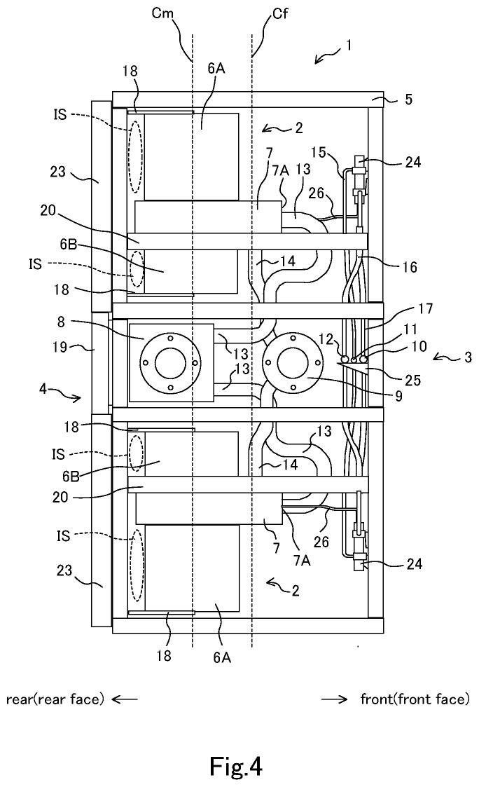

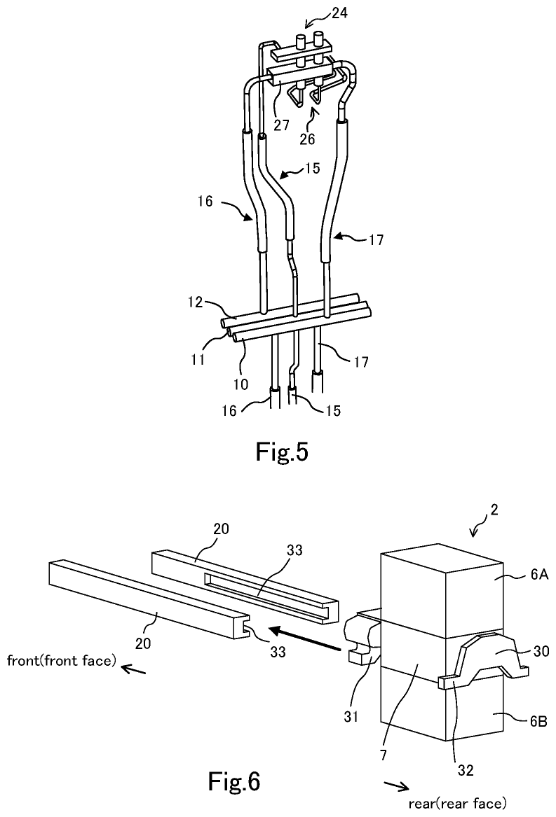

Next, a method of attaching the power generation module 2 to the frame body 5 will be described with reference to FIG. 6.

FIG. 6 is a view of the pair of cross members 20 and the power generation module 2 in a state before assembly, viewed from the rear side. At this stage, the first stay 22 is not attached to the frame body 5.

Facing faces of the pair of cross members 20 are provided with guide grooves 33 that extend in the front-rear direction (horizontal direction) and whose end portions on at least the rear side are open ends. The auxiliary machine structure 7 of the power generation module 2 is provided with a first slide portion 31 and a second slide portion 32 having shapes corresponding to the guide grooves 33. In FIG. 6, a slide member 30 including the second slide portion 32 is formed separately from the auxiliary machine structure 7 and is attached to the auxiliary machine structure 7. However, the second slide portion 32 may be formed integrally with the housing of the auxiliary machine structure 7.

Then, the rear face of the frame body 5 is used as an insertion face, the front face is used as a non-insertion face, and the power generation module 2 is moved from the insertion face along the guide groove 33 with the first slide portion 31 and the second slide portion 32, thereby inserting the power generation module 2 into the frame body 5. After the insertion, the power generation module 2 and the frame body 5 are rigidly connected using the first stay 22. Accordingly, the power generation module 2 is fixed to the frame body 5. At this time, if the guide groove 33 is provided from one end to the other end of the cross member 20, there is a need to position the power generation module 2 by inserting the power generation module 2 into the frame body 5 while checking the position of the power generation module 2. However, in the present embodiment, a position of the end portion of the guide groove 33 on the front side is aligned with a position of the first slide portion 31 when the power generation module 2 is appropriately positioned. In other words, positioning of the power generation module 2 is completed by inserting the power generation module 2 until the first slide portion 31 comes into contact with the end portion of the guide groove 33 on the front side. Accordingly, positioning is easier. In addition, since the insertion face is on the rear side, the connection portions between the auxiliary machine structure 7 and the respective pipes are on the front side of the auxiliary machine structure 7, and the respective pipes are routed while avoiding interference with a trajectory when the auxiliary machine structure 7 slides, the power generation module 2 can be removed from the frame body 5 by releasing connections with the respective pipes. That is, there is no need to remove the respective pipes from the frame body 5 when the power generation module 2 is replaced.

When the power generation module 2 is fixed to the frame body 5 as described above, the power generation module 2, in particular, the auxiliary machine structure 7 also functions as a structural member that connects the pair of cross members 20 provided on the left and right side faces of the frame body 5. The upper portion of the frame body 5 has face rigidity reinforced by the pair of cross members 20 on the left and right side faces, the second stay 21 on the front face and the second stay 21 on the back face, and the auxiliary machine structure 7 functions as a structural member that crosses the left and right side faces, improving rigidity of the entire upper portion. The same applies to the lower portion. Accordingly, deformation or collapse due to an external force such as an earthquake can be prevented.

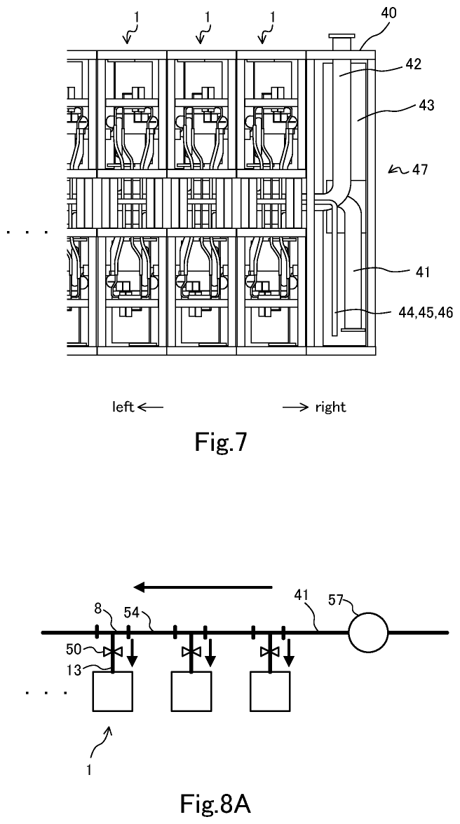

Next, a power generation plant using the fuel cell system 1 will be described with reference to FIG. 7.

FIG. 7 is a front view of the power generation plant using the fuel cell system 1.

As illustrated in the drawing, a plurality of fuel cell systems 1 are disposed adjacent to each other in the left-right direction, and the respective frame bodies 5 are rigidly connected to each other by bolts or the like. Accordingly, the pair of rigidly connected frame members function as reinforcing members, and deformation of the frame body 5 is prevented. The intake pipes 8, the exhaust pipes 9, the fuel pipes 11, and the cooling water pipes 10, 12 of the respective fuel cell systems 1 are also coupled. The intake pipes 8 of the adjacent fuel cell systems 1 are coupled via a pipe serving as a joint. The same applies to the exhaust pipe 9. The pipe serving as a joint includes flanges at both ends, and is made of a circular pipe member having a flow path cross section of the same shape as the openings provided in the flanges of the intake pipe 8 and the exhaust pipe 9. The fuel pipes 11 and the cooling water pipes 10, 12 of the adjacent fuel cell systems 1 are coupled via pipes serving as joints (for example, rubber pipes). As a result, the coupled linear intake pipe (main intake pipe) 8, exhaust pipe (main exhaust pipe) 9, fuel pipe (fuel main pipe) 11, and cooling water pipes 10, 12 are disposed between a row of the upper power generation modules 2A and a row of the lower power generation modules 2B. Further, the wirings accommodated in the power boxes 19 of the adjacent fuel cell systems 1 are electrically connected.

As described above, since the coupled intake pipes 8, exhaust pipes 9, fuel pipes 11, and cooling water pipes 10, 12 are linear, pressure loss can be prevented as compared with a case in which a bent portion is present. In addition, since all of these pipes can be accessed from the front side, operability is excellent.

As described above, the intake pipe 8 of each fuel cell system 1 has a flow path cross-sectional area of a portion interposed between the flanges provided on the left and right side faces (hereinafter, also referred to as a “flow path portion”) that is larger than the area of the opening in the flange, and a volume of the flow path portion is larger than that of the exhaust pipe 9. Therefore, the air supplied to the intake pipe 8 through the above joint is stored in the flow path portion and then flows into the intake branch pipe 13 connected to the upper power generation module 2A and the intake branch pipe 13 connected to the lower power generation module 2B. That is, the flow path portion functions similarly to a surge tank in an intake system of an internal combustion engine, and an effect such as equalization of air supplied to the two upper and lower power generation modules 2 is obtained.

A second frame body 40 is coupled to one end portion in the left-right direction (right end in FIG. 7) of a row in which a plurality of fuel cell systems 1 are coupled (hereinafter, also referred to as a fuel cell row). An air inlet pipe 41 having one end connected to the intake pipe 8, an exhaust outlet pipe 42 having one end connected to the exhaust pipe 9, a power converter 43, a fuel inlet pipe 45 having one end connected to the fuel pipe 11, a cooling water inlet pipe 44 having one end connected to the cooling water pipe 10, and a cooling water outlet pipe 46 having one end connected to the cooling water pipe 12 are fixedly supported by the second frame body 40. Hereinafter, the second frame body 40, the air inlet pipe 41, the exhaust outlet pipe 42, the power converter 43, the fuel inlet pipe 45, the cooling water inlet pipe 44, and the cooling water outlet pipe 46 are collectively referred to as an external connection module 47.

At the other end portion of the fuel cell row in the left-right direction, openings of the intake pipe 8, the exhaust pipe 9, and the fuel pipe 11 are closed by lids or plugs. An end of the cooling water pipe 10 and an end of the cooling water pipe 12 are connected.

The other end of the air inlet pipe 41 is connected to intake equipment (not illustrated) that is provided outside the fuel cell row and includes a blower 57 or the like. The other end of the exhaust outlet pipe 42 is open to the atmosphere. The other end of the exhaust outlet pipe 42 may be connected to exhaust treatment equipment (not illustrated) provided outside the fuel cell row.

The other end of the fuel inlet pipe 45 is connected to fuel equipment (not illustrated) that includes a fuel tank, a pressure-regulating valve, and the like. The other ends of the cooling water inlet pipe 44 and the cooling water outlet pipe 46 are connected to cooling equipment (not illustrated) that includes a cooling water tank, a circulation pump, a radiator, and the like.

The power converter 43 is electrically connected to each power box 19 of the fuel cell row via power wirings. That is, power generated by each power generation module 2 of the fuel cell row is output via one power converter 43. By consolidating the power converters 43 into one in this manner, the following effects can be obtained. First, an installation area of the power generation plant can be reduced as compared with a configuration in which the power converter 43 is disposed in each fuel cell system 1. In addition, when a cooling mechanism for the power converter 43 is provided, since only one place needs to be cooled, the configuration of the cooling mechanism is simplified, and cost thereof can be reduced. When more fuel cell systems 1 are coupled, a fuel cell row may be formed on a right side of the external connection module 47 in FIG. 7 in the same manner as on the left side thereof. In this case, the air inlet pipe 41, the exhaust outlet pipe 42, the fuel inlet pipe 45, the cooling water inlet pipe 44, and the cooling water outlet pipe 46 are respectively branched and connected also to the fuel cell row coupled on the right side. The same applies to the power wirings, and the fuel cell row on the right side is also electrically connected to the power converter 43.

The power generation module 2 of each fuel cell system 1 can be removed from the insertion face by disconnecting each of the pipes 13, 14, and 26 and the auxiliary machine structure 7 from the non-insertion face side, disconnecting the main power line and the branch power line on the insertion face side, and disconnecting the main wiring and the branch wiring of the power and signal lines. However, in the power generation plant including the plurality of fuel cell systems 1, since the intake pipe 8 and the exhaust pipe 9 of each of the fuel cell systems 1 are connected in series, the intake port 7A and the exhaust port 7B are brought into an atmosphere open state only by disconnecting the auxiliary machine structure 7 from the intake branch pipe 13 and the exhaust branch pipe 14. In this case, an operation of the power generation plant must be stopped to replace one power generation module 2.

Further, when the fuel cell system 1 is stopped for inspection or the like, there is a need to stop the supply of air and fuel gas. However, to inspect only a specific power generation module 2 while the power generation plant is operating, a mechanism for stopping only the supply to the power generation module 2 to be inspected is required. The same applies to a power transmission path and the power and signal lines, including the bus bar 18.

Therefore, the fuel cell system 1 according to the present embodiment has a mechanism that allows only the above specific power generation module 2 to be stopped, as described below.

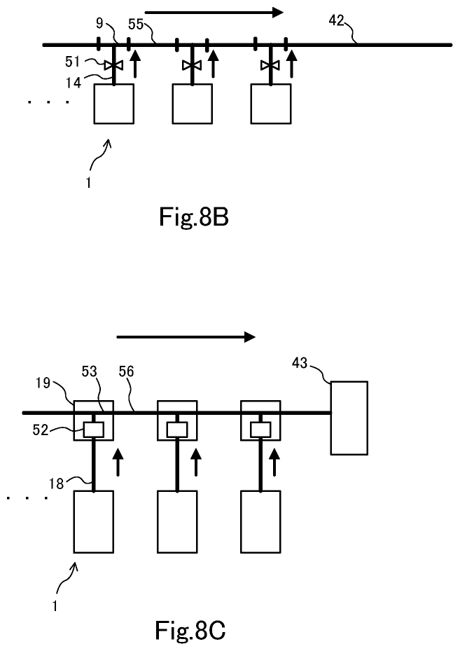

FIG. 8A is a diagram illustrating a pipe path of an intake system, FIG. 8B is a diagram illustrating a pipe path of an exhaust system, and FIG. 8C is a diagram illustrating a circuit of a power system that transmits power generated by the power generation module 2.

As illustrated in FIG. 8A, the intake system includes the main intake pipe, which includes the intake pipes 8 of respective fuel cell systems 1 and a joint 54 that connects them, the air inlet pipe 41 connected to the main intake pipe, the blower 57 that supplies air to the main intake pipe via the air inlet pipe 41, and the intake branch pipes 13 of respective fuel cell systems 1. Each intake branch pipe 13 is provided with a shutoff valve 50 capable of opening and closing the flow path. The shutoff valve 50 is omitted in FIG. 1 to FIG. 7.

As illustrated in FIG. 8B, the exhaust system includes the main exhaust pipe, which includes the exhaust pipes 9 of respective fuel cell systems 1 and a joint 55 that connects them, the exhaust outlet pipe 42 connected to the main exhaust pipe, and the exhaust branch pipes 14 of respective fuel cell systems 1. Each exhaust branch pipe 14 is provided with a shutoff valve 51 capable of opening and closing the flow path. The shutoff valve 51 is omitted in FIG. 1 to FIG. 7.

As illustrated in FIG. 8C, the power system includes main power lines 53 of respective fuel cell system 1, a power line 56 that connects them, the power converter 43, and the bus bars 18 of respective fuel cell systems 1. Each bus bar 18 is provided with a circuit breaker 52. The circuit breaker 52 is omitted in FIG. 1 to FIG. 7.

Although not illustrated, a shutoff valve is also provided between the fuel pipe 11 and the fuel injection unit 24.

Next, effects obtained by the above fuel cell system 1 and the power generation plant using the same will be described.

In the present embodiment, there is provided a stationary fuel cell system 1 including: a power generation module 2 including an auxiliary machine structure 7 including an auxiliary machine that receives and transmits gas from and to a fuel cell stack 6, and a fuel cell stack 6 connected to at least one face of the auxiliary machine structure 7 in an up-down direction; a box-shaped frame body 5 made of a plurality of frame members, the power generation module 2 being disposed inside the frame body 5. The system further including: pipes 8, 9, and 11 through which gas supplied to the power generation module 2 or discharged from the power generation module 2 flows; and branch pipes 13, 14, and 15 branched from the pipes 8, 9 and connected to the power generation module. The auxiliary machine structure 7 is supported by cross members 20 each extending in a horizontal direction and provided on each of a pair of side faces of the frame body 5 facing each other with the power generation module 2 therebetween. When one of a pair of side faces of the frame body 5, orthogonal to any of the pair of side faces on which the cross member 20 is provided, is an insertion face through which the power generation module 2 passes when inserting the power generation module 2 into the frame body 5, and the other is a non-insertion face, a connection portion between the branch pipes 13, 14 and the auxiliary machine structure 7 is on a non-insertion face side of the auxiliary machine structure 7.

Accordingly, for example, when the fuel cell stack needs to be replaced, the intake branch pipe 13, the exhaust branch pipe 14, and the fuel supply pipe 26 can be collectively disconnected from the non-insertion face side, and thus the operability of maintenance and the like is excellent.

In the present embodiment, each of the pair of cross members 20 includes a guide groove 33 extending in a longitudinal direction of the cross member 20. The auxiliary machine structure 7 includes a slide portion 31 that slidably engages with the guide groove 33. The guide groove 33 has an open end at an end portion on an insertion face side and a closed end at an end portion on the non-insertion face side. The power generation module 2 is fixed to the frame body 5 in a state in which the closed end of the guide groove 33 and the slide portion 31 are brought into contact with each other. That is, since a position of the power generation module 2 is determined by a relationship between a position of the end portion of the guide groove 33 on the non-insertion face side and the slide portion 31, making positioning easy.

In the present embodiment, a first stay 22 that rigidly connects the auxiliary machine structure 7 to a pair of frame members facing each other among frame members constituting the insertion face of the frame body 5. Accordingly, the power generation module 2 can be fixed to the frame body 5 in a positioned state. Further, the power generation module 2, in particular, the auxiliary machine structure 7 functions as a structural member, and rigidity of the frame body 5 is increased.

In the present embodiment, among the intake branch pipe 13, the exhaust branch pipe 14, and the fuel supply pipe 26, at least the exhaust branch pipe 14 is made of a metal pipe member. Accordingly, thermal deterioration of the exhaust branch pipe 14 through which high-temperature exhaust gas flows can be prevented.

In the present embodiment, the intake branch pipe 13, the exhaust branch pipe 14, and the fuel supply pipe 26 are routed while avoiding interference with a trajectory of the power generation module 2 when the auxiliary machine structure 7 slides along the guide groove 33. Accordingly, when the power generation module 2 is removed, the power generation module 2 does not interfere with the disconnected intake branch pipe 13, exhaust branch pipe 14, and fuel supply pipe 26, and thus the power generation module 2 is easily detached.

In the present embodiment, the stationary fuel cell system further including: a fuel injection unit 24 configured to inject fuel into the power generation module 2; a fuel pipe 11 through which the fuel flows, as the pipes; a fuel branch pipe configured to connect the fuel pipe 11 and the fuel injection unit 24, as the branch pipes; a fuel supply pipe 26 configured to connect the fuel injection unit 24 and the auxiliary machine structure 7; an inlet cooling water pipe 10 through which cooling water to be supplied to the fuel injection unit 24 flows; and an outlet cooling water pipe 12 through which cooling water after cooling the fuel injection unit 24 flows. The inlet cooling water pipe 10 is disposed on the non-insertion face side with respect to the fuel pipe 11, and the outlet cooling water pipe 12 is disposed on the insertion face side with respect to the fuel pipe 11. As described above, since the fuel pipe 11 is disposed at a position interposed between the intake pipe 8 through which relatively low-temperature intake air flows and the exhaust pipe 9 through which relatively high-temperature exhaust gas flows, fuel flowing through the fuel pipe 11 is maintained at a temperature at which the fuel is likely to be evaporated after injection and bubbles are not generated.

In the present embodiment, each of the stationary fuel cell systems 1 including a pipe module 3 including the intake pipe 8, the exhaust pipe 9, and the fuel pipe 11, a power box 19 that recovers power generated by the power generation module 2, and a bus bar 18 (power wiring) that connects the power box 19 and the power generation module 2. A main intake pipe and a main exhaust pipe are formed by connecting the pipe modules 3 of the adjacent stationary fuel cell systems 1. A power generation plant further including: an external connection module 47 including an air inlet pipe 41 that is connected to the main intake pipe and introduces air from external equipment, an exhaust outlet pipe 42 that is connected to the main exhaust pipe and discharges air to an outside, and a power converter 43 that is connected to the power box 19 of each stationary fuel cell system 1 and aggregates and outputs power generated by each stationary fuel cell system 1. The intake branch pipe 13, the exhaust branch pipe 14, and the fuel pipe 11 of each stationary fuel cell system 1 are provided with shutoff valves 50, 51, and each bus bar 18 is provided with a circuit breaker 52. Accordingly, any fuel cell system 1 among the fuel cell systems 1 included in the power generation plant can be individually stopped. As a result, maintenance and inspection operations are easier.

Although the embodiment of the present invention has been described above, the above embodiment merely exemplifies a part of application examples of the present invention and does not intend to limit the technical scope of the present invention to the specific configuration of the above embodiment.

1. A stationary fuel cell system comprising:
a power generation module including an auxiliary machine structure including an auxiliary machine that receives and transmits gas from and to a fuel cell stack, and a fuel cell stack connected to at least one face of the auxiliary machine structure in an up-down direction;
a box-shaped frame body made of a plurality of frame members, the power generation module being disposed inside the frame body;
pipes through which gas supplied to the power generation module or discharged from the power generation module flows; and
branch pipes branched from the pipes and connected to the power generation module, wherein
the auxiliary machine structure is supported by cross members each extending in a horizontal direction and provided on each of a pair of side faces of the frame body facing each other with the power generation module therebetween, and
when one of a pair of side faces of the frame body, orthogonal to any of the pair of side faces on which the cross member is provided, is an insertion face through which the power generation module passes when inserting the power generation module into the frame body, and the other is a non-insertion face, a connection portion between the branch pipes and the auxiliary machine structure is on a non-insertion face side of the auxiliary machine structure.

2. The stationary fuel cell system according to claim 1, wherein
each of the pair of cross members includes a guide groove extending in a longitudinal direction of the cross member,
the auxiliary machine structure includes a slide portion that slidably engages with the guide groove,
the guide groove has an open end at an end portion on an insertion face side and a closed end at an end portion on the non-insertion face side, and
the power generation module is fixed to the frame body in a state in which the closed end of the guide groove and the slide portion are brought into contact with each other.

3. The stationary fuel cell system according to claim 2, further comprising:
a first stay configured to rigidly connect the auxiliary machine structure to a pair of frame members facing each other among frame members constituting the insertion face of the frame body.

4. The stationary fuel cell system according to claim 2, wherein
the pipes include an intake pipe through which air to be supplied to the power generation module flows and an exhaust pipe through which gas discharged from the power generation module flows, and
the branch pipes include an intake branch pipe that connects the intake pipe and the auxiliary machine structure, and an exhaust branch pipe that connects the exhaust pipe and the auxiliary machine structure.

5. The stationary fuel cell system according to claim 4, wherein
of the intake branch pipe and the exhaust branch pipe, at least the exhaust branch pipe is made of a metal pipe member.

6. The stationary fuel cell system according to claim 4, wherein
the intake branch pipe, the exhaust branch pipe, and the fuel supply pipe are routed to avoid interference with a trajectory of the power generation module when the auxiliary machine structure slides along the guide groove.

7. The stationary fuel cell system according to claim 1, further comprising:
a fuel injection unit configured to inject fuel into the power generation module;
a fuel pipe through which the fuel flows, as the pipes;
a fuel branch pipe configured to connect the fuel pipe and the fuel injection unit, as the branch pipes;
a fuel supply pipe configured to connect the fuel injection unit and the auxiliary machine structure;
an inlet cooling water pipe through which cooling water to be supplied to the fuel injection unit flows; and
an outlet cooling water pipe through which cooling water after cooling the fuel injection unit flows, wherein
the inlet cooling water pipe is disposed on the non-insertion face side with respect to the fuel pipe, and the outlet cooling water pipe is disposed on the insertion face side with respect to the fuel pipe.

8. A power generation plant comprising:
a plurality of the stationary fuel cell systems according to claim 1, each of the stationary fuel cell systems including a pipe module including the pipes and the branch pipes, a power box that recovers power generated by the power generation module, and a power wiring that connects the power box and the power generation module, and a main intake pipe and a main exhaust pipe being formed by connecting the pipe modules of the adjacent stationary fuel cell systems; and
an external connection module including an air inlet pipe that is connected to the main intake pipe and introduces air from external equipment, an exhaust outlet pipe that is connected to the main exhaust pipe and discharges air to an outside, and a power converter that is connected to the power box of each stationary fuel cell system and aggregates and outputs power generated by each stationary fuel cell system, wherein
each of the branch pipes of the stationary fuel cell systems is provided with a shutoff valve, and each of the power wirings is provided with a circuit breaker.
